(19) United States
(12) Patent Application Publication
(10) Pub. No.: US 2015/0094202 A1
(43) Pub. Date: Apr. 2, 2015

(54) PROCESSES FOR ACTIVATING ADSORBENT MATERIALS IN ADSORBED GAS SYSTEMS

(71) Applicant: BASF Corporation, Florham Park, NJ (US)

(72) Inventors: William Dolan, Yardley, PA (US); Christoph Garbotz, Mannheim (DE); Adam Lack, New York, NY (US); Joseph Lynch, Sparta, NJ (US); Stefan Marx, Dirmstein (DE); Ulrich Mueller, Neustadt (DE); Michael SantaMaria, Monmouth Junction, NJ (US); Mathias Weickert, Ludwigshafen (DE)

(21) Appl. No.: 14/498,342

(22) Filed: Sep. 26, 2014

Related U.S. Application Data
(60) Provisional application No. 61/883,603, filed on Sep. 27, 2013.
(60) Provisional application No. 61/883,669, filed on Sep. 27, 2013.
(60) Provisional application No. 61/883,704, filed on Sep. 27, 2013.

(51) Int. Cl. B01J 20/30; B65B 31/02

(52) U.S. Cl. CPC B01J 20/3092; B01J 20/3085; B01J 20/3078; B65B 31/02
USPC 502/401; 53/432; 53/440

(57) ABSTRACT

Disclosed in certain embodiments are methods of filling storage containers with adsorbent materials (e.g., metal organic framework) and methods to increase the storage capacity of the adsorbent materials

### CROSS REFERENCE TO RELATED APPLICATIONS

This application claims the benefit of priority of U.S. Provisional Patent Application No. 61/883,603, filed Sep. 27, 2013, U.S. Provisional Patent Application No. 61/883,669, filed Sep. 27, 2013, and U.S. Provisional Patent Application No. 61/883,704, filed Sep. 27, 2013, all of which are hereby incorporated by reference herein in their entireties.

### BACKGROUND OF THE DISCLOSURE

Adsorbent materials can be used for the storage of gas. A particular adsorbent, metal organic framework, is a highly crystalline structure with nanometer-sized pores that allow for the storage of natural gas and other gases such as hydrocarbon gas, hydrogen and carbon dioxide. Metal organic framework can also be used in other applications such as gas purification, gas separation and in catalysis.

These materials are typically in particle form and essentially consist of two types of building units: metal ions (e.g. zinc, aluminum) and organic compounds. Each of the organic compounds can attach to at least two metal ions (at least bidentate), serving as a linker for them. In this way a three dimensional, regular framework is spread apart containing empty pores and channels, the sizes of which are defined by the size of the organic linker.

The high surface area provided by metal organic framework can be used for many applications such as gas storage, gas/vapor separation, heat exchange, catalysis, luminescence and drug delivery. By way of example, metal organic framework can have (show) a specific surface area of up to 10,000 m²/g determined by Langmuir model.

A particular application of metal organic framework is for gas storage (e.g., natural gas) in gas powered vehicles. The larger specific surface area and high porosity on the nanometer scale enable metal organic framework to hold relatively large amounts of gases. Used as storage materials in natural gas tanks, metal organic framework offers a docking area for gas molecules, which can be stored in higher densities as a result. The larger gas quantity in the tank can increase the range of a vehicle. The metal organic framework can also increase the usable time of stationary gas powered applications such as generators and machinery.

There exists a need in the art for systems and methods of preparing storage containers with adsorbent materials (e.g., metal organic framework) that are suitable for the storage of gas. There also exists a need in the art for systems and methods to increase the gas storage efficiency of adsorbent materials

### OBJECTS AND SUMMARY OF THE DISCLOSURE

It is an object of certain embodiments to provide methods of filling adsorbent materials (e.g., metal organic framework) into containers.

It is an object of certain embodiments to provide methods to activate adsorption materials (e.g., metal organic framework) in order to increase their capacity for gas adsorption.

It is an object of certain embodiments to provide containment systems suitable for adsorbed gas storage.

It is an object of certain embodiments to provide gas powered machines (e.g., vehicles, heavy equipment) that utilize the containment systems disclosed herein.

It is an object of certain embodiments to provide vehicles and heavy equipment that comprise the containment systems disclosed herein.

The above objects and others, may be met by the present disclosure, which in certain embodiments is directed to a method of filling a container with adsorption particles (e.g., metal organic framework) including providing a container suitable for adsorbed gas storage having a capacity, e.g., of at least 1 liter and at least partially filling the container with metal organic framework particles. In certain embodiments, the ratio of the tapped density of the particles to the ratio of the freely settled density of the particles is at least 1.1. In other embodiments, the tapped density is, e.g., from about 0.1 g/cm³ to about 10 g/cm³, or 0.2 g/cm³ to about 1 g/cm³ depending on the selection of materials.

Certain embodiments are directed to a containment system including a container suitable for adsorbed gas storage having a capacity of at least 1 liter at least partially filled with metal organic framework particles such that the ratio of the tapped density of the particles to the ratio of the freely settled density of the particles is greater than 1 (e.g., 1.1 or more).

Certain other embodiments are directed to a method of activating metal organic framework particles including subjecting the metal organic framework particles to conditions selected from the group consisting of above ambient temperature, vacuum, an inert gas flow and a combination thereof, for a sufficient time to activate the particles.

Certain other embodiments are directed to a containment system including a container suitable for adsorbed gas storage having a capacity of at least 1 liter at least partially filled with activated metal organic framework particles.

Certain other embodiments are directed to a vehicle including a containment system as disclosed herein.

As used herein, the term “natural gas” refers to a mixture of hydrocarbon gases that occurs naturally beneath the Earth's surface, often with or near petroleum deposits. Natural gas typically comprises methane but also may have varying amounts of ethane, propane, butane, and nitrogen.

The terms “adsorbed gas container” or “container suitable for adsorbed gas storage” refer to a container that maintains its integrity when filled or partially filled with an adsorption material that can store a gas. In certain embodiments, the container is suitable to hold the adsorbed gas under pressure or compression.

The terms “vehicle” or “automobile” refer to any motorized machine (e.g., a wheeled motorized machine) for (i) transporting of passengers or cargo or (ii) performing tasks such as construction or excavation. Vehicles can have, e.g., at least 2 wheels (e.g., a motorcycle or motorized scooter), at least 3 wheels (e.g., an all-terrain vehicle), at least 4 wheels (e.g., a passenger automobile), at least 6 wheels, at least 8 wheels, at least 10 wheels, at least 12 wheels, at least 14 wheels, at least 16 wheels or at least 18 wheels. The vehicle can be, e.g., a bus, refuse vehicle, freight truck, construction vehicle, heavy equipment, military vehicle or tractor. The vehicle can also be a train, aircraft, watercraft, submarine or spacecraft.

The term “activation” refers to the treatment of adsorption materials (e.g., metal organic framework particles) in a manner to increase their storage capacity. Typically, the treatment results in removal of contaminants (e.g., water, non-aqueous solvent, sulfur compounds and higher hydrocarbons) from adsorption sites in order to increase the capacity of the materials for their intended purpose.

The term “adsorbent material” refers to a material (e.g., adsorbent particles) that can adhere gas molecules within its structure for subsequent use in an application. Specific materials include but are not limited to metal organic framework, activated alumina, silica gel, activated carbon, molecular sieve carbon, zeolites (e.g., molecular sieve zeolites), polymers, resins and clays.

The term “particles” when referring to adsorbent materials such as metal organic framework refers to multiparticulates of the material having any suitable size such as 0.0001 mm to about 50 mm or 1 mm to 20 mm. The morphology of the particles may be crystalline, semi-crystalline, or amorphous. The term also encompasses powders and particles down to 1 nm. The size ranges disclosed herein can be mean or median size.

The term “monolith” when referring to absorbent materials refers to a single block of the material. The single block can be in the form of, e.g., a brick, a disk or a rod and can contain channels for increased gas flow/distribution. In certain embodiments, multiple monoliths can be arranged together to form a desired shape.

The term “fluidly connected” refers to two or more components that are arranged in such a manner that a fluid (e.g., a gas) can travel from one component to another component either directly or indirectly (e.g., through other components or a series of connectors).

The term “freely settled density” or “bulk density” is determined by measuring the volume of a known mass of particles. The measurement can be determined using the procedures described in Method I or Method II of the United States Pharmacopeia 26, section <616>, hereby incorporated by reference.

The term “tapped density” is determined by measuring the volume of a known mass of particles after agitating the materials or container or using any of the filling techniques disclosed herein. The measurement can be determined by modifying procedures described in Method I or Method II of the United States Pharmacopeia 26, section <616>, hereby incorporated by reference. The procedures therein can be modified to provide a “tapped density” after any physical manipulation of the container and/or particles, e.g., after vibrating the container or using the filling techniques as disclosed herein. The measurement can also be determined using modification of DIN 787-11 (ASTM B527).

### BRIEF DESCRIPTION OF THE DRAWINGS

The present disclosure is illustrated by way of example, and not by way of limitation, in the figures of the accompanying drawings in which like references indicate similar elements. It should be noted that different references to “an” or “one” embodiment, “certain” embodiments, or “some” embodiments in this disclosure are not necessarily to the same embodiment, and such references mean at least one.

FIG. 1 depicts an activation system of the present disclosure with an inert gas flow and external heat;

FIG. 2 depicts an activation system of the present disclosure with an inert gas flow and internal;

FIG. 3 depicts an activation system of the present disclosure with a vacuum, flow indicator and external heat; and

FIG. 4 is a flow diagram illustrating a method for preparing a containment system.

### DETAILED DESCRIPTION

The filling of adsorption materials into storage containers has many associated problems due to the adsorption materials being exposed to moisture and other environmental contaminants. This is especially a problem with metal organic framework particles that are manufactured in large batch sizes and suitable for inclusion in high capacity tanks, e.g., for use on a vehicle. The greater the amount of particles being filled into the tank and the greater the size of the tank allows for increased opportunity for the material to be exposed to contaminants. Thus, disclosed herein are methods that can be used to prepare containment systems that minimize the exposure of adsorption material (e.g., metal organic framework particles) to contaminants.

Also disclosed herein are methods to treat adsorption materials (e.g., metal organic framework particles) in a manner to increase their storage capacity (referred to as “activation”). Surface area of the adsorption particles may be occupied by a material (e.g., water molecules or residual solvent molecules from manufacture) other than the material that is intended to be adsorbed (e.g., natural gas). Thus, the adsorption capacity of the particles is reduced as not all of the surface area is available to adsorb the desired material. By virtue of the present disclosure, there are provided methods of removing contaminants such as water, non-aqueous solvent molecules, sulfur compounds and higher hydrocarbon gases from adsorption sites in order to increase capacity. This process is referred to as “activation”.

### Methods of Filling Containers and Corresponding Systems

Certain embodiments are directed to a method of filling a container with metal organic framework particles including providing a container suitable for adsorbed gas storage having a capacity of at least 1 liter and at least partially filling the container with metal organic framework particles such that the ratio of the tapped density of the particles to the ratio of the freely settled density of the particles is at least 1.1.

Certain embodiments are directed to a method of filling a container with metal organic framework particles including providing a container suitable for adsorbed gas storage having a capacity of at least 1 liter and at least partially filling the container with metal organic framework particles such the tapped density is, depending on the selection of materials, e.g., from about 0.1 g/cm³ to about 10 g/cm³, from about 0.2 g/cm³ to about 5 g/cm³, 0.2 g/cm³ to about 1 g/cm³, or from about 0.3 g/cm³ to about 0.8 g/cm³.

The filling process may include shifting or moving (intermittently or constantly) the container during at least a portion of the filling. Alternatively, or in addition, the filling may include shifting or moving the container after the filling with the metal organic framework particles. The shifting or moving of the container may include, e.g., shaking, rolling, vibrating or subjection to centrifugal force.

The filling process may also include the use of a tube to transfer the metal organic framework particles from a storage vessel to the container. The tube can be any suitable dimension such as, e.g., an elongated cylinder. A funnel may also be utilized in the filling process. The funnel can be incorporated as an integral part of the tube or can be a separate apparatus that is connected with the tube.

During the filling process, the container can be positioned such that the stream of particles during the filling is downward. In a particular embodiment, the stream of particles during the filling is downward at any suitable angle to effect filling, e.g., at an angle of between about 135° and about 225° from a vertical axis.

In order to minimize the exposure of filling material to contaminants, the tube can be sealed to the container inlet during the filling, sealed to the storage vessel outlet during the filling or sealed to both the container inlet and the storage vessel outlet during the filling.

In certain embodiments, the tube is at an initial position at the start of the filling and the tube is raised upward to a second position at the end of the filling. The tube may be raised intermittently or constantly from the initial position to the second position during the filling. Further, the tube may be raised at a fixed rate or at a varied rate from the initial position to the second position during the filling. In still further embodiments, the tube is raised linearly or non-linearly (e.g., in a circular or corkscrew manner) from the initial position to the second position during the filling.

The filling process may also use a deflector within or in proximity of the inlet of the container in order to maximize the distribution of the particles within the container.

One or more steps of the filling process may also be performed under an inert atmosphere (e.g., nitrogen) in order to minimize exposure of the materials to contaminants.

The filling process may also include the manipulation of the particles in order to facilitate the process. Such manipulations may include, e.g., surface roughness control, low friction coatings, electrostatic charge reduction, or any other suitable parameters that may facilitate loading. In certain embodiments, the particles may be treated with one or more lubricants or binders prior to filling. For example, the particles may be treated with a graphite lubricant to facilitate flow during filling.

The methods disclosed herein encompass the filling of containers such as cylinders, tanks or any other container that is suitable for storing adsorbed gas. The container can be suitable for adsorption, containment, and/or transportation of natural gas, hydrocarbon gas (e.g., methane, ethane, butane, propane, pentane, hexane, isomers thereof and a combination thereof), air, oxygen, nitrogen, synthetic gas, hydrogen, carbon monoxide, carbon dioxide, helium, or any other gas, or combinations thereof that can be adsorbed in a container for a variety of uses. In certain embodiments, the container may be electrically grounded during filling for safety concerns. In certain embodiments, the container is adapted to contain a quantity of compressed gas to provide a range of operation for a vehicle of about 5 miles or more, of about 10 miles or more, of about 25 miles or more, of about 50 miles or more, of about 100 miles or more, or about 200 miles or more.

The containers disclosed herein can be suitable for use in a compressed gas vehicle (such as a road vehicle or an off-road vehicle) or in heavy equipment (such as construction equipment). The containers can also be used in stationary systems such as generators.

The vehicle can have, e.g., at least 2 wheels (e.g., a motorcycle or motorized scooter), at least 3 wheels (e.g., an all-terrain vehicle), at least 4 wheels (e.g., a passenger automobile), at least 6 wheels, at least 8 wheels, at least 10 wheels, at least 12 wheels, at least 14 wheels, at least 16 wheels or at least 18 wheels. The vehicle can be, e.g., a bus, refuse vehicle, freight truck, construction vehicle, or tractor.

The adsorption container can have a capacity, e.g., of at least about 1 liter, at least about 5 liters, at least about 10 liters, at least about 50 liters, at least about 75 liters, at least about 100 liters, at least about 200 liters, or at least about 400 liters. In certain embodiments, a vehicle fuel system can include multiple containers (e.g., tanks), e.g., at least 2 containers, at least 4 containers, at least 6 containers or at least 8 containers. In certain embodiment, the fuel system can contain 2 containers, 3 containers, 4 containers, 5 containers, 6 containers, 7 containers, 8 containers, 9 containers or 10 containers.

When filled into the container, the ratio of the tapped density of the particles to the ratio of the freely settled density of the particles can be greater than 1, e.g., at least about 1.1, at least about 1.2, at least about 1.5, at least about 1.7, at least about 2.0 or at least about 2.5.

The adsorbent material (e.g., particles) that may be utilized using the methods disclosed herein can be metal organic framework, e.g., having a surface area of at least about 500 m²/g, at least about 700 m²/g, at least about 1000 m²/g, at least about 1200 m²/g, at least about 1500 m²/g, at least about 1700 m²/g, at least about 2000 m²/g, at least about 5000 m²/g or at least about 10,000 m²/g.

The surface area of the material may be determined by the BET (Brunauer-Emmett-Teller) method according to DIN ISO 9277:2003-05 (which is a revised version of DIN 66131). The specific surface area is determined by a multipoint BET measurement in the relative pressure range from 0.05-0.3 p/p₀.

In certain embodiments the adsorbent material includes a zeolite. In certain embodiments a chemical formula of the zeolite is of a form of M_{x/n}[(AlO₂)ₓ(SiO₂)_{y}].mH₂O, where x, y, m, and n are integers greater than or equal to 0, and M is a metal selected from the group consisting of Na and K.

In other embodiments the adsorbent material is a zeolitic material in which the framework structure is composed of YO₂ and X₂O₃, in which Y is a tetravalent element and X is a trivalent element. In one embodiment Y is selected from the group consisting of Si, Sn, Ti, Zr, Ge, and combinations of two or more thereof. In one embodiment Y is selected from the group consisting of Si, Ti, Zr, and combinations of two or more thereof. In one embodiment Y is Si and/or Sn. In one embodiment Y is Si. In one embodiment X is selected from the group consisting of Al, B, In, Ga, and combinations of two or more thereof. In one embodiment X is selected from the group consisting of Al, B, In, and combinations of two or more thereof. In one embodiment X is Al and/or B. In one embodiment X is Al.

In certain embodiments, the metal organic framework particles may include a metal selected from the group consisting of Li, Mg, Ca, Sc, Y, Zr, V, Mn, Fe, Co, Ni, Cu, Zn, B, Al, Ti and a combination thereof. In certain embodiments, the MOF particles include a metal selected from the group consisting of Al, Mg, Zn, Cu, Zr, and a combination thereof.

In certain embodiments, the bidentate organic linker has at least two atoms which are selected independently from the group consisting of oxygen, sulfur and nitrogen via which an organic compound can coordinate to the metal. These atoms can be part of the skeleton of the organic compound or be functional groups. In certain embodiments the MOF particles include a moiety selected from the group consisting of a phenyl moiety, an imidazole moiety, an alkane moiety, an alkyne moiety, a pyridine moiety, a pyrazole moiety, an oxole moiety, and a combination thereof. In certain embodiments the MOF particles include at least one moiety selected from the group consisting of fumaric acid, formic acid, 2-methylimidazole, and trimesic acid.

As functional groups through which the abovementioned coordinate bonds can be formed, mention may be made by way of example of, in particular: OH, SH, NH₂, NH(—R—H), N(R—H)₂, CH₂OH, CH₂SH, CH₂NH₂, CH₂NH(—R—H), CH₂N(—R—H)₂, —CO₂H, COSH, —CS₂H, —NO₂, —B(OH)₂, —SO₃H, —Si(OH)₃, —Ge(OH)₃, —Sn(OH)₃, —Si(SH)₄, —Ge(SH)₄, —Sn(SH)₃, —PO₃H₂, —AsO₃H, —AsO₄H, —P(SH)₃, —As(SH)₃, —CH(RSH)₂, —C(RSH)₃, —CH(RNH₂)₂, —C(RNH₂)₃, —CH(ROH)₂, —C(ROH)₃—CH(RCN)₂, —C(RCN)₃, where R may be, for example, an alkylene group having 1, 2, 3, 4 or 5 carbon atoms, for example a methylene, ethylene, n-propylene, isopropylene, n-butylene, isobutylene, tert-butylene or n-pentylene group, or an aryl group having 1 or 2 aromatic rings, for example 2C₆ rings, which may, if appropriate, be fused and may, independently of one another, be appropriately substituted by, in each case, at least one substituent and/or may, independently of one another, include, in each case, at least one heteroatom, for example N, O and/or S. In likewise embodiments, mention may be made of functional groups in which the abovementioned radical R is not present. In this regard, mention may be made of, inter alia, —CH(SH)₂, —C(SH)₃, —CH(NH₂)₂, CH(NH(R—H))₂, CH(N(R—H)₂)₂, C(NH(R—H))₃, C(N(R—H)₂)₃, —C(NH₂)₃, —CH(OH)₂, —C(OH)₃, —CH(CN)₂, —C(CN)₃.

The at least two functional groups can in principle be bound to any suitable organic compound as long as it is ensured that the organic compound including these functional groups is capable of forming the coordinate bond and of producing the framework.

The organic compounds which include the at least two functional groups are derived from a saturated or unsaturated aliphatic compound or an aromatic compound or a both aliphatic and aromatic compound.

The aliphatic compound or the aliphatic part of the both aliphatic and aromatic compound can be linear and/or branched and/or cyclic, with a plurality of rings per compound also being possible. The aliphatic compound or the aliphatic part of the both aliphatic and aromatic compound may include from 1 to 18, 1 to 14, 1 to 13, 1 to 12, 1 to 11, or 1 to 10 carbon atoms, for example 1, 2, 3, 4, 5, 6, 7, 8, 9 or 10 carbon atoms. For example, certain embodiments may include, inter alia, methane, adamantane, acetylene, ethylene or butadiene.

The aromatic compound or the aromatic part of the both aromatic and aliphatic compound can have one or more rings, for example two, three, four or five rings, with the rings being able to be present separately from one another and/or at least two rings being able to be present in fused form. The aromatic compound or the aromatic part of the both aliphatic and aromatic compound particularly may have one, two, or three rings. Furthermore, each ring of the compound can include, independently of one another, at least one heteroatom such as N, O, S, B, P, and/or Si. The aromatic compound or the aromatic part of the both aromatic and aliphatic compound may include one or two C₆ rings; in the case of two rings, they can be present either separately from one another or in fused form. Aromatic compounds of which particular mention may be made are benzene, naphthalene and/or biphenyl and/or bipyridyl and/or pyridyl.

The at least bidentate organic compound may be derived from a dicarboxylic, tricarboxylic or tetracarboxylic acid or a sulfur analogue thereof. Sulfur analogues are the functional groups —C(═O)SH and its tautomer and C(═S)SH, which can be used in place of one or more carboxylic acid groups.

For the purposes of the present disclosure, the term “derived” means that the at least bidentate organic compound can be present in partly deprotonated or completely deprotonated form in a MOF subunit or MOF-based material. Furthermore, the at least bidentate organic compound can include further substituents such as —OH, —NH₂, —OCH₃, —CH₃, —NH(CH₃), —N(CH₃)₂, —CN and halides. In certain embodiments, the at least bidentate organic compound may be an aliphatic or aromatic acyclic or cyclic hydrocarbon which has from 1 to 18 carbon atoms and, in addition, has exclusively at least two carboxy groups as functional groups.

For the purposes of the present disclosure, mention may be made by way of example of dicarboxylic acids, as may be used to realize any of the embodiments disclosed herein, such as oxalic acid, succinic acid, tartaric acid, 1,4-butanedicarboxylic acid, 1,4-butene-dicarboxylic acid, 4-oxopyran-2,6-dicarboxylic acid, 1,6-hexanedicarboxylic acid, decanedicarboxylic acid, 1,8-heptadecanedicarboxylic acid, 1,9-heptadecanedicarboxylic acid, heptadecanedicarboxylic acid, acetylenedicarboxylic acid, 1,2-benzenedicarboxylic acid, 1,3-benzenedicarboxylic acid, 2,3-pyridinedicarboxylic acid, pyridine-2,3-dicarboxylic acid, 1,3-butadiene-1,4-dicarboxylic acid, 1,4-benzenedicarboxylic acid, p-benzenedicarboxylic acid, imidazole-2,4-dicarboxyolic acid, 2-methylquinoline-3,4-dicarboxylic acid, quinoline-2,4-dicarboxylic acid, quinoxaline-2,3-dicarboxylic acid, 6-chloroquinoxaline-2,3-dicarboxylic acid, 4,4′-diaminophenylmethane-3,3′-dicarboxylic acid, quinoline-3,4-dicarboxylic acid, 7-chloro-4-hydroxyquinoline-2,8-dicarboxylic acid, diimidedicarboxylic acid, pyridine-2,6-dicarboxylic acid, 2-methylimidazole-4,5-dicarboxylic acid, thiophene-3,4-dicarboxylic acid, 2-isopropylimidazole-4,5-dicarboxylic acid, tetrahydropyran-4,4-dicarboxylic acid, perylene-3,9-dicarboxylic acid, perylenedicarboxylic acid, Pluriol E 200-dicarboxylic acid, 3,6-dioxa-octanedicarboxylic acid, 3,5-cyclohexadiene-1,2-dicarboxylic acid, octadicarboxylic acid, pentane-3,3-dicarboxylic acid, 4,4′-diamino-1,1′-biphenyl-3,3′-dicarboxylic acid, 4,4′-diaminobiphenyl-3,3′-dicarboxylic acid, benzidine-3,3′-dicarboxylic acid, 1,4-bis(phenylamino)benzene-2,5-dicarboxylic acid, 1,1′-binaphthyldicarboxylic acid, 7-chloro-8-methylquinoline-2,3-dicarboxylic acid, 1-anilinoanthraquinone-2,4′-dicarboxylic acid, polytetrahydrofuran-250-dicarboxylic acid, 1,4-bis(carboxymethyl)piperazine-2,3-dicarboxylic acid, 7-chloroquinoline-3,8-dicarboxylic acid, 1-(4-carboxy)phenyl-3-(4-chloro)phenyl-pyrazoline-4,5-dicarboxylic acid, 1,4,5,6,7,7-hexachloro-5-norbornene-2,3-dicarboxylic acid, phenylindanedicarboxylic acid, 1,3-dibenzyl-2-oxoimidazolidine-4,5-dicarboxylic acid, 1,4-cyclohexanedicarboxylic acid, naphthalene-1,8-dicarboxylic acid, 2-benzoylbenzene-1,3-dicarboxylic acid, 1,3-dibenzyl-2-oxoimidazolidine-4,5-cis-dicarboxylic acid, 2,2′-biquinoline-4,4′-dicarboxylic acid, pyridine-3,4-dicarboxylic acid, 3,6,9-trioxaundecanedicarboxylic acid, hydroxybenzophenonedicarboxylic acid, Pluriol E 300-dicarboxylic acid, Pluriol E 400-dicarboxylic acid, Pluriol E 600-dicarboxylic acid, pyrazole-3,4-dicarboxylic acid, 2,3-pyrazinedicarboxylic acid, 5,6-dimethyl-2,3-pyrazinedicarboxylic acid, (bis(4-aminophenyl) ether)diimidedicarboxylic acid, 4,4′-diaminodiphenylmethanediimidedicarboxylic acid, (bis(4-aminophenyl) sulfone)diimidedicarboxylic acid, 1,4-naphthalenedicarboxylic acid, 2,6-naphthalenedicarboxylic acid, 1,3-adamantanedicarboxylic acid, 1,8-naphthalenedicarboxylic acid, 2,3-naphthalenedicarboxylic acid, 8-methoxy-2,3-naphthalenedicarboxylic acid, 8-nitro-2,3-naphthalenecarboxylic acid, 8-sulfo-2,3-naphthalenedicarboxylic acid, anthracene-2,3-dicarboxylic acid, 2′,3′-diphenyl-p-terphenyl-4,4″-dicarboxylic acid, (diphenyl ether)-4,4′-dicarboxylic acid, imidazole-4,5-dicarboxylic acid, 4(1H)-oxothiochromene-2,8-dicarboxylic acid, 5-tert-butyl-1,3-benzenedicarboxylic acid, 7,8-quinolinedicarboxylic acid, 4,5-imidazoledicarboxylic acid, 4-cyclohexene-1,2-dicarboxylic acid, hexatriacontanedicarboxylic acid, tetradecanedicarboxylic acid, 1,7-heptadicarboxylic acid, 5-hydroxy-1,3-benzenedicarboxylic acid, 2,5-dihydroxy-1,4-dicarboxylic acid, pyrazine-2,3-dicarboxylic acid, furan-2,5-dicarboxylic acid, 1-nonene-6,9-dicarboxylic acid, eicosenedicarboxylic acid, 4,4′-dihydroxydiphenylmethane-3,3′-dicarboxylic acid, 1-amino-4-methyl-9,10-dioxo-9,10-dihydro-anthracene-2,3-dicarboxylic acid, 2,5-pyridinedicarboxylic acid, cyclohexene-2,3-dicarboxylic acid, 2,9-dichlorofluorubin-4,11-dicarboxylic acid, 7-chloro-3-methylquinoline-6,8-dicarboxylic acid, 2,4-dichlorobenzophenone-2′,5′-dicarboxylic acid, 1,3-benzenedicarboxylic acid, 2,6-pyridinedicarboxylic acid, 1-methylpyrrole-3,4-dicarboxylic acid, 1-benzyl-1H-pyrrole-3,4-dicarboxylic acid, anthraquinone-1,5-dicarboxylic acid, 3,5-pyrazoledicarboxylic acid, 2-nitrobenzene-1,4-dicarboxylic acid, heptane-1,7-dicarboxylic acid, cyclobutane-1,1-dicarboxylic acid, 1,14-tetradecanedicarboxylic acid, 5,6-dehydronorbornane-2,3-dicarboxylic acid, 5-ethyl-2,3-pyridinedicarboxylic acid or camphordicarboxylic acid, tricarboxylic acids such as 2-hydroxy-1,2,3-propanetricarboxylic acid, 7-chloro-2,3,8-quinolinetricarboxylic acid, 1,2,3-, 1,2,4-benzenetricarboxylic acid, 1,2,4-butanetricarboxylic acid, 2-phosphono-1,2,4-butanetricarboxylic acid, 1,3,5-benzenetricarboxylic acid, 1-hydroxy-1,2,3-propanetricarboxylic acid, 4,5-dihydro-4,5-dioxo-1H-pyrrolo[2,3-F]quinoline-2,7,9-tricarboxylic acid, 5-acetyl-3-amino-6-methylbenzene-1,2,4-tricarboxylic acid, 3-amino-5-benzoyl-6-methylbenzene-1,2,4-tricarboxylic acid, 1,2,3-propanetricarboxylic acid or aurintricarboxylic acid, or tetracarboxylic acids such as 1,1-dioxidoperylo[1,12-BCD]thiophene-3,4,9,10-tetracarboxylic acid, perylene-tetracarboxylic acids such as perylene-3,4,9,10-tetracarboxylic acid or (perylene 1,12-sulfone)-3,4,9,10-tetracarboxylic acid, butanetetracarboxylic acids such as 1,2,3,4-butanetetracarboxylic acid or meso-1,2,3,4-butanetetracarboxylic acid, decane-2,4,6,8-tetracarboxylic acid, 1,4,7,10,13,16-hexaoxacyclooctadecane-2,3,11,12-tetracarboxylic acid, 1,2,4,5-benzenetetracarboxylic acid, 1,2,11,12-dodecanetetracarboxylic acid, 1,2,5,6-hexanetetracarboxylic acid, 1,2,7,8-octanetetracarboxylic acid, 1,4,5,8-naphthalenetetracarboxylic acid, 1,2,9,10-decanetetracarboxylic acid, benzophenonetetracarboxylic acid, 3,3′,4,4′-benzophenonetetracarboxylic acid, tetrahydrofurantetracarboxylic acid or cyclopentanetetracarboxylic acids such as cyclopentane-1,2,3,4-tetracarboxylic acid.

Certain embodiments may use at least monosubstituted aromatic dicarboxylic, tricarboxylic or tetracarboxylic acids which have one, two, three, four or more rings and in which each of the rings can include at least one heteroatom, with two or more rings being able to include identical or different heteroatoms. For example, certain embodiments may use one-ring dicarboxylic acids, one-ring tricarboxylic acids, one-ring tetracarboxylic acids, two-ring dicarboxylic acids, two-ring tricarboxylic acids, two-ring tetracarboxylic acids, three-ring dicarboxylic acids, three-ring tricarboxylic acids, three-ring tetracarboxylic acids, four-ring dicarboxylic acids, four-ring tricarboxylic acids and/or four-ring tetracarboxylic acids. Suitable heteroatoms are, for example, N, O, S, B, and/or P. Suitable substituents which may be mentioned in this respect are, inter alia, —OH, a nitro group, an amino group or an alkyl or alkoxy group.

In certain embodiments, the linker may include a moiety selected from the group consisting of a phenyl moiety, an imidazole moiety, an alkane moiety, an alkyne moiety, a pyridine moiety, a pyrazole moiety, an oxole moiety and a combination thereof. In a particular embodiment, the linker may be a moiety selected from any of the moieties illustrated in Table 1.

TABLE 1
Linker Moieties

| | |
|---|---|
| 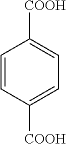 [SMILES: O=C(O)c1ccc(C(=O)O)cc1] | Moiety 1 |
| 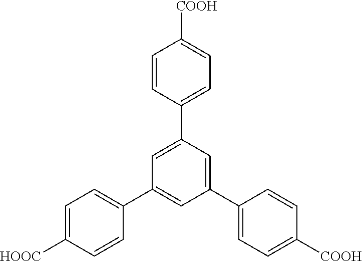 [SMILES: O=C(O)c1ccc(-c2cc(-c3ccc(C(=O)O)cc3)cc(-c3ccc(C(=O)O)cc3)c2)cc1] | Moiety 2 |
| 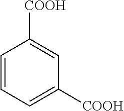 [SMILES: O=C(O)c1cccc(C(=O)O)c1] | Moiety 3 |
| 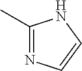 | Moiety 4 |
| 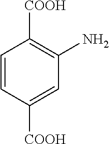 [SMILES: Nc1cc(C(=O)O)ccc1C(=O)O] | Moiety 5 |
| 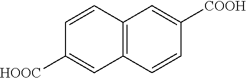 [SMILES: O=C(O)c1ccc2cc(C(=O)O)ccc2c1] | Moiety 6 |
| 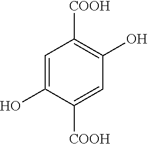 [SMILES: O=C(O)c1cc(O)c(C(=O)O)cc1O] | Moiety 7 |
| 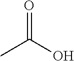 | Moiety 8 |
| 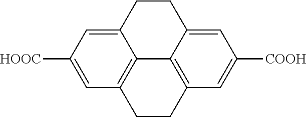 [SMILES: O=C(O)c1cc2c3c(c1)CCc1cc(C(=O)O)cc(c1-3)CC2] | Moiety 9 |
| 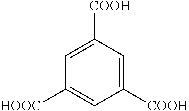 [SMILES: O=C(O)c1cc(C(=O)O)cc(C(=O)O)c1] | Moiety 10 |
| 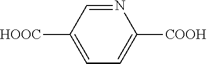 [SMILES: O=C(O)c1ccc(C(=O)O)nc1] | Moiety 11 |
| 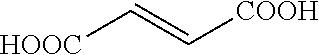 | Moiety 12 |
| 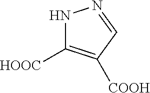 [SMILES: O=C(O)c1cn[nH]c1C(=O)O] | Moiety 13 |
| 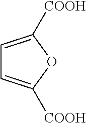 [SMILES: O=C(O)c1ccc(C(=O)O)o1] | Moiety 14 |
| 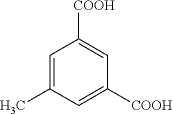 | Moiety 15 |

The MOF particles can be in any form, such as, e.g., pellets, extrudates, beads, powders or any other defined or irregular shape. The particles can be any size, e.g., from about 0.0001 mm to about 10 mm, from about 0.001 mm to about 5 mm, from about 0.01 mm to about 3 mm, or from about 0.1 mm to about 1 mm.

Also disclosed herein are containment systems that are prepared utilizing the filling methods disclosed herein. In one embodiment, the containment system includes a container suitable for compressed/adsorbed gas storage having a capacity of at least 1 liter at least partially filled with metal organic framework particles such that the ratio of the tapped density of the particles to the ratio of the freely settled density of the particles is at least 1.1. Still further embodiments are directed to vehicles including a containment system as disclosed herein. Other embodiments are directed to methods of manufacturing such vehicles by integrating a container as disclosed herein into a fuel system of a vehicle. The fuel system can be part of an assembly of a new vehicle or can be retrofitted into an existing vehicle.

In certain embodiments, the metal organic framework particles can be incorporated into a matrix material and thereafter introduced into a container. The matrix may be a plastic material in any suitable form such as a sheet which can be formed, e.g., by extrusion. The material can be optionally corrugated. The material can be rolled or otherwise manipulated and incorporated into a container. Prior to introduction into a container, the material can be bound by polymer fibers.

### Activation of Particles

Certain embodiments are directed to a method of activating adsorption particles (e.g., metal organic framework particles) including subjecting the adsorption particles to conditions selected from the group consisting of above ambient temperature, heat, vacuum, an inert gas flow and a combination thereof, for a sufficient time to activate the particles.

In certain embodiments, the activation includes the removal of water molecules from the adsorption sites. In other embodiments, the activation includes the removal of non-aqueous solvent molecules from the adsorption sites that are residual from the manufacture of the particles. In still further embodiments, the activation includes the removal of sulfur compounds or higher hydrocarbons from the adsorption sites. In embodiments utilizing an inert gas purge in the activation process, a subsequent solvent recovery step is also contemplated. In certain embodiments, the contaminants (e.g., water, non-aqueous solvents, sulfur compounds or higher hydrocarbons) are removed from the adsorption material at a molecular level.

In a particular embodiment, the activation includes the removal of water molecules from the surface area of the particles. After activation, the particles may have a moisture content of less than about 10%, less than about 8%, less than about 5%, less than about 3%, less than about 1%, less than about 0.8%, less than about 0.5%, less than about 0.3% or less than about 0.1% by weight of the particles. Alternatively, the available surface area of the adsorption material for adsorption of the intended gas is greater than about 80%, greater than about 85%, greater than about 90%, greater than about 95% or greater than about 98% of the accepted value (i.e., the theoretical surface area free of adsorbed contaminants).

The activation can occur before or after the particles are filled into a container suitable for adsorbed gas storage. Alternatively, the particles may be removed and activated external to a container suitable. Activating particles outside of the container may be beneficial in certain circumstances as the container may have temperature limitations that may impede the activation process. The external process may also result in a shorter activation time due to the ability to apply a higher temperature to the particles outside of the tank.

Certain embodiments are directed to the activation of metal organic framework particles. The particles can be subject to a suitable temperature for removal of contaminants (e.g., water, non-aqueous solvents, sulfur compounds and higher hydrocarbons) from adsorption sites. The activation may include exposure of the metal organic framework particles to a temperature, e.g., above about 40° C., above about 60° C., above about 100° C., above about 150° C., above about 250° C., or above about 350° C. In other embodiments, the temperature may be between about 40° C. and about 400° C., between about 60° C. and about 250° C., between about 100° C. and about 200° C., between about 60° C. and about 200° C., between about 60° C. and about 180° C., between about 60° C. and about 170° C., between about 60° C. and about 160° C., between about 150° C. and about 200° C. or between about 150° C. and about 180° C.

The activation of particles may be subject to a vacuum in order to remove contaminants (e.g., water, non-aqueous solvents, sulfur compounds and higher hydrocarbons) from adsorption sites. The vacuum may be, e.g., from about 10% to about 80% below atmospheric pressure, from about 10% to about 50% below atmospheric pressure, from about 10% to about 20% below atmospheric pressure, from about 20% to about 30% below atmospheric pressure or from about 30% to about 40% below atmospheric pressure.

The activation of the particles can also include flowing inert gas through the material to remove contaminants (e.g., water, non-aqueous solvents, sulfur compounds and higher hydrocarbons). The inert gas flow can include nitrogen or a noble gas. The total amount of inert gas used in the purge can be any suitable amount to activate the materials. In a particular embodiment, the amount of gas is at least the volume of a container holding the particles. In other embodiments, the amount of gas is at least 2 times the container volume or at least 3 times the container volume. The inert gas can be flowed through the materials for any suitable time, such as at least about 10 minutes, at least about 30 minutes, at least about 1 hour, at least about 6 hours, at least about 8 hours, at least about 16 hours, at least about 24 hours or at least about 48 hours. Alternatively, the time can be from about 10 minutes to about 48 hours, from about 10 minutes to about 28 hours, from about 10 minutes to about 16 hours, from about 30 minutes to about 48 hours, from about 30 minutes to about 24 hours, from about 30 minutes to about 16 hours, from about 1 hour to about 48 hours, from about 1 hour to about 24 hours, from about 1 hour to about 16 hours, from about 10 minutes to about 1 hour, from about 30 minutes to about 1 hour, from about 2 hours to about 24 hours, or from about 4 hours to about 16 hours. In some embodiments, the time can be from at least about 5 minutes.

Any amount of adsorbent material (e.g., MOF particles) may be activated according to the methods described herein, or a combination thereof. In a particular embodiment, the particles may be in an amount of at least about 1 kg, at least about 500 kg, from about 20 kg to about 500 kg, from about 50 kg to about 300 kg or from about 100 kg to about 200 kg. In another embodiment, the adsorbent material may be in an amount of at least about 1 g, at least about 500 g, from about 20 g to about 500 g, from about 50 g to about 300 g, from about 100 g to about 200 g, or greater than 500 g.

The activated particles can be at least partially filled into a container suitable for compressed gas storage, e.g., having a capacity of at least about 1 liter. The filling can optionally encompass any of the filling procedures disclosed herein. The filling of activated particles may also result in the tapped density of particles disclosed herein.

After the particles are filled into a suitable adsorption container, the activation can occur by placing the container in an oven. Alternatively, if the container is mounted onto a vehicle or machinery (e.g., a generator), a heat source internal to the vehicle or machinery can be used. For example, the heat source in a vehicle may be derived from the battery, engine, air conditioning unit, brake system, or a combination thereof. In alternative embodiments, the container at least partially filled with particles can be activated with an external heat source.

In certain embodiments, a microwave energy source may be utilized to provide microwave energy to heat and activate the particles. In some embodiments, the microwave energy source may be part of the container or located externally to the container. In some embodiments, more than one microwave energy source may be used. In some embodiments, one or more microwave energy sources may be utilized along with other energy sources to activate the particles.

In other embodiments, if the container is mounted onto a vehicle or machinery, a vacuum source internal or external to the vehicle or machinery can be used for activation. For example, the energy source in a vehicle for the internal vacuum may be derived from the battery, engine, the air conditioning unit, the brake system, or a combination thereof.

In embodiments wherein the container is mounted onto a vehicle or machinery, it may be necessary at a point in time after the initial activation to re-activate the particles. For instance, after one or more cycles wherein the container is filled with a compressed gas with subsequent release (e.g., upon running the vehicle), certain contaminants may remain on the adsorption sites. These contaminants may include sulfur compounds or higher hydrocarbons (e.g., C₄₋₆ hydrocarbons). The reactivation can include subjecting the particles in the container to heat, vacuum and/or inert gas flow for a sufficient time for reactivation. In one embodiment, the reactivation can occur at a service visit or can be performed at a standard fueling station. The reactivation can also include washing and/or extraction of the particles in the container with non-aqueous solvent or water.

The time period for the activation or reactivation of the particles can be determined by measuring the flow of water or non-aqueous solvent in a vacuum. In a certain embodiment, the flow is terminated when the water or solvent content is less than about 10%, less than about 8%, less than about 5%, less than about 3%, less than about 1%, less than about 0.8%, less than about 0.5%, less than about 0.3% or less than about 0.1% by weight of the particles.

In certain embodiments, the container can include a heating element in order to provide activation of the materials after filling. The energy for the heating element can be provided internally from the vehicle (e.g., from a battery, engine, air conditioning unit, brake system, or a combination thereof) or externally from the vehicle. Whether the activation is before or after filling, the container may be dried prior to the introduction of particles into the container. The container can be dried, e.g., with air, ethanol, heat or a combination thereof.

When the particles are activated outside of the container, it may be necessary to store and/or ship the particles prior to incorporation into an adsorption container. In certain embodiments, the activated particles are stored in a plastic receptacle with an optional barrier layer between the receptacle and the particles. The barrier layer may include, e.g., one or more plastic layers.

When the particles are activated by an inert gas flow, the flow may be initiated at an inlet of the container and may be terminated at an outlet of the container at a different location than the inlet. In alternative embodiments, the inert gas flow is initiated and terminated at the same location on the container.

The inert gas flow may include the utilization of a single tube for introducing and removing the inert gas from the container. In such an embodiment, the tube may include an outer section with at least one opening to allow the inert gas to enter the container and an inner section without openings to allow for the inert gas to be removed from the container. In other embodiments, the flow may include the utilization of a first tube for introducing the inert gas into the container and a second tube to remove the inert gas from the container.

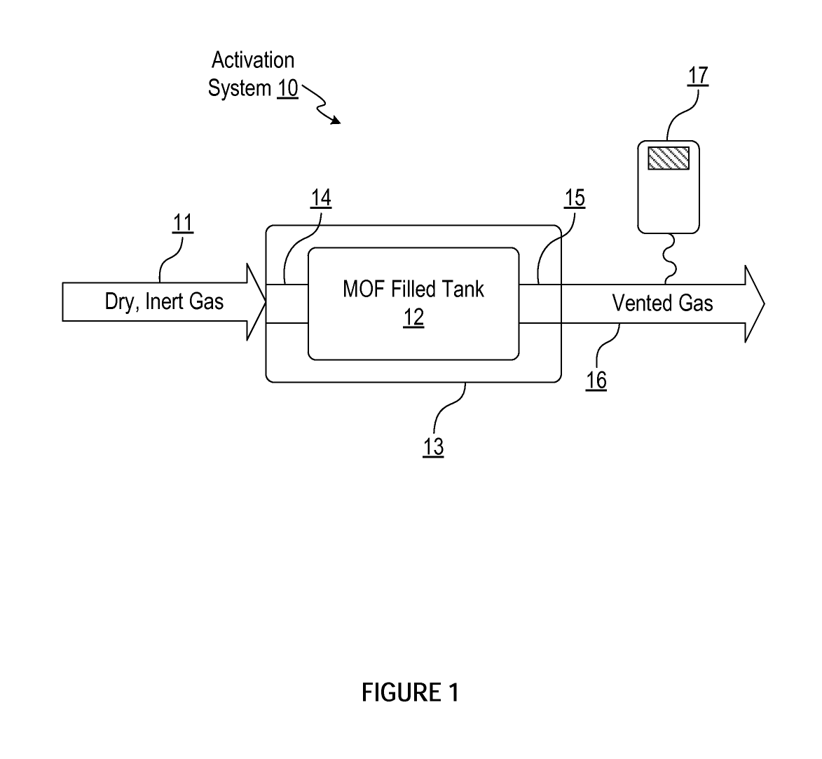

FIG. 1 depicts an activation system (10) of the present disclosure with an inert gas flow (11) into a MOF filled tank (12) in which external heat is provided to the MOF filled tank (12) by an oven (13). The inert gas flow (11) is introduced into the MOF filled tank (12) through a container inlet (14) that is fluidly connected to an inert gas source. The inert gas flow (11) exits through a container outlet (15). An O₂ meter (17) is operatively coupled to the activation system (10) to measure O₂ content of an outflow (16) of vented gas.

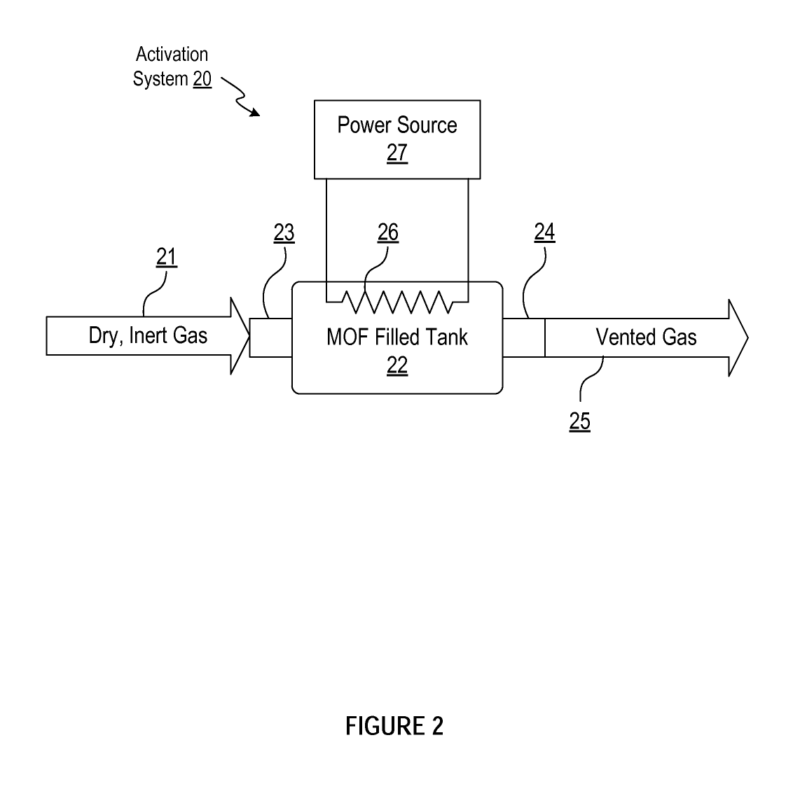

FIG. 2 depicts an activation system (20) of the present disclosure with an inert gas flow (21) and internal heat provided by a coil (26) contained within a MOF filled tank (22). The coil (26) is connected to an external power source (27). The inert gas flow (21) is introduced into the MOF filled tank (22) through a container inlet (23) that is fluidly connected to an inert gas source, with vented gas (25) exiting through a container outlet (24).

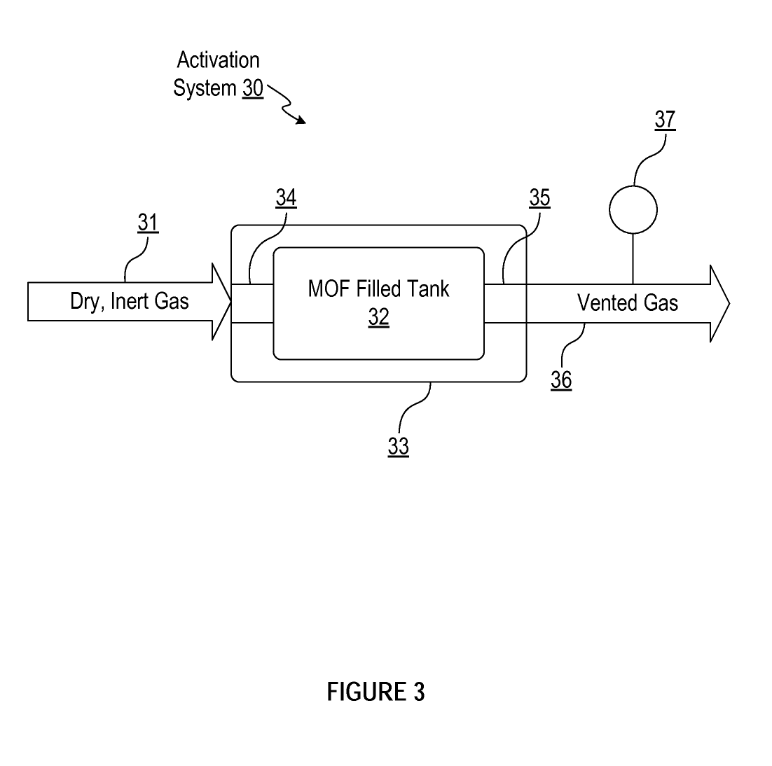

FIG. 3 depicts an activation system (30) of the present disclosure with an inert gas flow (31) into a MOF filled tank (32) in which external heat is provided to the MOF filled tank (32) by an oven (33). The inert gas flow (31) is introduced into the MOF filled tank (32) through a container inlet (34) that is fluidly connected to an inert gas source. The inert gas flow (31) exits through a container outlet (35). A flow meter (37) is operatively coupled to the activation system (10) to measure O₂ content of an outflow (36) of vented gas.

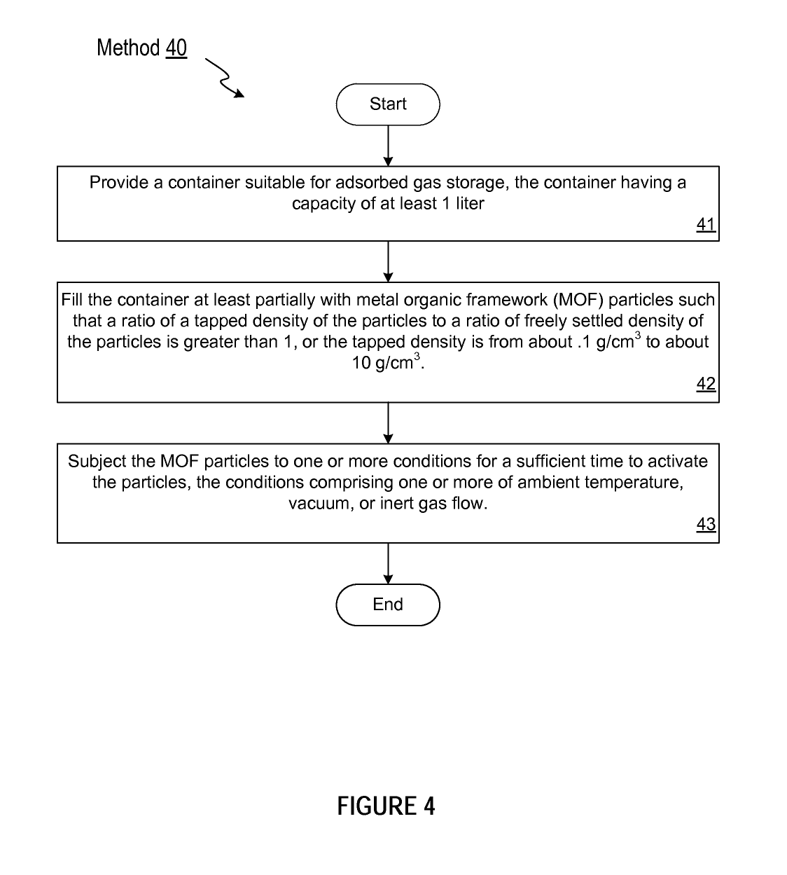

FIG. 4 is a flow diagram illustrating a method (40) for preparing a containment system. At block (41), a container is provided, the container being suitable for adsorbed gas storage and having a capacity of at least 1 liter. At block (42), the container is filled at least partially with MOF particles such that a ratio of a tapped density of the particles to a ratio of freely settled density of the particles is greater than 1, or the tapped density is from about 0.1 g/cm³ to about 10 g/cm³ depending on which materials were selected. At block (43), the MOF particles are subjected to one or more conditions for a sufficient time to activate the particles (e.g., according to any of the embodiments described herein). The conditions may include one or more of ambient temperature, vacuum, or inert gas flow. In some embodiments, the activation is performed using any of activation system (10), activation system (20), or activation system (30).

For simplicity of explanation, the embodiments of the methods of this disclosure are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events.

Certain embodiments are directed to containment systems including the activated particles as disclosed herein. For example, one embodiment is directed to a containment system including a container suitable for compressed gas storage having a capacity of at least 1 liter at least partially filled with activated metal organic framework particles.

The activated particles of the present disclosure may be filled or partially filled in containers such as cylinders, tanks or any other container that is suitable for storing adsorbed gas. The container can be suitable for adsorption of natural gas, hydrocarbon gas (e.g., methane, ethane, butane, propane, pentane, hexane, isomers thereof and a combination thereof), air, oxygen, nitrogen or any other gas that can be adsorbed in a container for a variety of uses.

The containers filled or partially filled with activated particles of the present disclosure can be suitable for use in a compressed gas vehicle (such as a road vehicle or an off-road vehicle) or in machinery (such as generators and construction equipment).

The vehicles fitted with containers filled or partially filled with activated adsorbent particles may have, e.g., at least 2 wheels (e.g., a motorcycle or motorized scooter), at least 3 wheels (e.g., an all-terrain vehicle), at least 4 wheels (e.g., a passenger automobile), at least 6 wheels, at least 8 wheels, at least 10 wheels, at least 12 wheels, at least 14 wheels, at least 16 wheels or at least 18 wheels. The vehicle can be, e.g., a bus, refuse vehicle, freight truck, construction vehicle, or tractor.

The adsorption container filled or at least partially filled with activated particles can have a capacity, e.g., of at least about 1 liter, at least about 5 liters, at least about 10 liters, at least about 50 liters, at least about 75 liters, at least about 100 liters, at least about 200 liters, or at least about 400 liters.

The activated particles as disclosed herein can be metal organic framework particles, e.g., having a surface area of at least about 500 m²/g, at least about 700 m²/g, at least about 1000 m²/g, at least about 1200 m²/g, at least about 1500 m²/g, at least about 1700 m²/g, at least about 2000 m²/g, at least about 5000 m²/g or at least about 10,000 m²/g.

Certain embodiments are directed to containment systems that are prepared utilizing the activated adsorbent particles disclosed herein. In one embodiment, the containment system includes a container suitable for adsorbed gas storage having a capacity of at least 1 liter at least partially filled with activated metal organic framework particles. Still further embodiments are directed to vehicles including a containment system with activated adsorbent particles as disclosed herein.

Disclosure herein specifically directed to metal organic framework is also contemplated to be applicable to other adsorbent materials such as activated alumina, silica gel, activated carbon, molecular sieve carbon, zeolites (e.g., molecular sieve zeolites), polymers, resins and clays.

Also, disclosure herein with respect to adsorbent particles is also contemplated to be applicable to monoliths of the material where applicable.

In the foregoing description, numerous specific details are set forth, such as specific materials, dimensions, processes parameters, etc., to provide a thorough understanding of the present invention. The particular features, structures, materials, or characteristics may be combined in any suitable manner in one or more embodiments. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Reference throughout this specification to “an embodiment”, “certain embodiments”, or “one embodiment” means that a particular feature, structure, or characteristic described in connection with the embodiment is included in at least one embodiment. Thus, the appearances of the phrase “an embodiment”, “certain embodiments”, or “one embodiment” in various places throughout this specification are not necessarily all referring to the same embodiment.

The present invention has been described with reference to specific exemplary embodiments thereof. It will, however, be evident that various modifications and changes may be made thereto without departing from the broader scope of the embodiments of the invention as set for in the appended claims. The specification and drawings are, accordingly, to be regarded in an illustrative rather than a restrictive sense.

1. A method of activating metal organic framework particles comprising subjecting the metal organic framework particles to conditions selected from the group consisting of above ambient temperature, vacuum, an inert gas flow and a combination thereof, for a sufficient time to activate the particles.

2. The method of claim 1, wherein the metal organic framework particles, after activation, have a moisture or solvent content of less than about 0.1% by weight or wherein an available surface area for adsorption of an intended gas for adsorption is greater than about 80%, greater than about 85%, greater than about 90%, greater than about 95% or greater than about 98% of an accepted value.

3. The method of claim 1, wherein the particles are activated in a container suitable for adsorbed gas storage.

4. The method of claim 1, wherein the particles are activated external to a container suitable for adsorbed gas storage.

5. The method of claim 1, wherein the metal organic framework particles are subjected to a temperature above about 40° C.

6-8. (canceled)

9. The method of claim 1, wherein the metal organic framework particles are subjected to vacuum from about 10% to about 50% below atmospheric pressure.

10-12. (canceled)

13. The method of claim 1, further comprising a solvent recovery step for the inert gas flow.

14. (canceled)

15. (canceled)

16. The method of claim 1, wherein the time to activate the particles is from about 10 minutes to about 48 hours.

17. (canceled)

18. (canceled)

19. The method of claim 1, wherein the metal organic framework particles are in an amount of at least about 1 kg.

20-25. (canceled)

26. The method of claim 3, wherein the container is suitable for use in a compressed gas vehicle, wherein the compressed gas vehicle is a road vehicle or an off-road vehicle.

27-33. (canceled)

34. The method of claim 3, wherein the container has a capacity of at least about 5 liters.

35-40. (canceled)

41. The method of claim 1, wherein the metal organic framework particles have a surface area of at least about 500 m²/g.

42-47. (canceled)

48. The method of claim 1, wherein the metal organic framework particles comprise a metal selected from the group consisting of Li, Mg, Ca, Sc, Y, Zr, V, Mn, Fe, Co, Ni, Cu, Zn, B, Al and, a combination thereof.

49. The method of claim 1, wherein the metal organic framework particles comprise a moiety selected from the group consisting of a phenyl moiety, an imidazole moiety, a pyridine moiety, a pyrazole moiety, an oxole moiety, and a combination thereof.

50. (canceled)

51. The method of claim 1, wherein the activation removes non-aqueous solvent.

52. The method of claim 1, wherein the activation removes water.

53. The method of claim 1, wherein the activation removes water at a molecular level.

54. The method of claim 4, wherein the metal organic framework particles, after activation, are at least partially filled into the container, wherein the container has a capacity of at least 1 liter.

55. The method of claim 54, wherein the filling is performed under an inert atmosphere.

56. (canceled)

57. The method of claim 3, wherein the container is mounted to a vehicle and the particles are activated by utilizing a vehicle heat source.

58. (canceled)

59. The method of claim 3, wherein the container is mounted to a vehicle and the particles are activated by utilizing an external heat source.

60. The method of claim 3, wherein the container is mounted to a vehicle and the particles are activated by utilizing a vehicle vacuum source.

61-64. (canceled)

65. The method of claim 64, wherein the reactivation removes sulfur compounds or hydrocarbon gases from the particles.

66. The method of claim 64, wherein the reactivation removes a hydrocarbon gas selected from the group consisting of propane, pentane, hexane, isomers thereof, and a combination thereof.

67. The method of claim 64, wherein the container is mounted on a vehicle.

68. The method of claim 1, wherein the time to activate the particles is determined by measuring a flow of solvent in the vacuum.

69. The method of claim 68, wherein the activation is terminated when a moisture content or solvent content is less than about 0.1 weight %.

70. The method of claim 3, further comprising a heating element within the container.

71-75. (canceled)

76. The method of claim 70, wherein the container is mounted on a vehicle and an energy to power the heating element is derived internally from the vehicle.

77. The method of claim 76, wherein the energy is derived from an engine, an air conditioning unit, a brake system, or a combination thereof.

78. The method of claim 70, wherein the container is mounted on a vehicle and an energy to power the heating element is derived externally from the vehicle.

79. The method of claim 3, wherein the inert gas flow is initiated at an inlet of the container and is terminated at an outlet of the container at a different location than the inlet.

80. The method of claim 3, wherein the inert gas flow is initiated and terminated at a same location on the container.

81. The method of claim 79, comprising a single tube for introducing and removing the inert gas from the container.

82. The method of claim 81, wherein the tube comprises an outer section with at least one opening to allow the inert gas to enter the container and an inner section without openings to allow for the inert gas to be removed from the container.

83. The method of claim 79, comprising a tube for introducing the inert gas into the container and a second tube to remove the inert gas from the container.

84-133. (canceled)
